(19) United States
(12) Patent Application Publication
(10) Pub. No.: US 2006/0190433 A1
(43) Pub. Date: Aug. 24, 2006

(54) Distributed navigation business activities data

(75) Inventors: Gueorgui B. Chkodrov, Redmond, WA (US); Richard Z. Jason, Seattle, WA (US); John D. Ballard, Woodinville, WA (US); Chun Yu, Bothell, WA (US); David S. Taniguchi, Kirkland, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/063,622

(22) Filed: Feb. 23, 2005

(51) Int. Cl. G06F 17/30

(52) U.S. Cl. 707/3

(57) ABSTRACT

Business activity management of monitoring multiple instances of a business activity and navigating business activity data in a distributed system. A system includes a plurality of databases storing data relating to multiple instances of a monitored business activity. A user interface receives a request from a user for business activity data independent of which database stores the requested data. An activity monitoring component for navigating to one of the databases as a function of defined relationships to retrieve the requested business activity data. The user interface displays the retrieved data to the user based on the user's permission.

### TECHNICAL FIELD

Embodiments of the present invention generally relate to the field of monitoring business activities. In particular, embodiments of this invention relate to monitoring multiple instances of business activities and organizing and accessing data and documents in a distributed system for relatively seamless retrieval of data independent of where the data is stored.

### BACKGROUND OF THE INVENTION

Business entities engage in numerous activities based on a variety of automated processes (e.g., relying on computerized activities and business software applications) and operations based on human actions (e.g., phone calls, faxes, e-mails, etc.). As a result, obtaining an accurate snapshot of “what is going on with the business” becomes more complex and critical for businesses to make quick decisions to leverage market opportunities or to prevent losses.

Businesses and other organizations use computers, and in particular, computer database applications, to monitor and record information about organizational activities. Often, an organization will have recurring processes or activities that must be performed. Indeed, it is common for an organization to have numerous instances of an activity in various stages of completion at any given time. As one example, a business may sell goods based on orders received from customers. An activity of interest may be fulfilling those customer orders; each purchase order represents a separate instance of that activity. At any particular time, that business may have multiple instances of the activity (i.e., multiple orders from multiple customers) in various stages of completion. As another example, a financial institution may loan funds to customers based on applications from those customers. An activity of interest may be the processing of a loan application to completion (e.g., approval or rejection), with each loan application representing a separate instance of the activity. At any particular time, there may be multiple loan application instances in various stages of processing. As yet another example, a governmental entity responsible for issuing permits may have multiple permit applications in various stages of being processed.

In facilitating management of business activities, a system known as “Business Activity Monitoring” (BAM) concentrates and analyzes data from and for heterogeneous event sources in an attempt to present a single real-time view of the business state, trends, and critical conditions. Businesses or enterprise entities that successfully monitor business activities will be able to make decisions faster based on more relevant data, and therefore will gain significant advantage. Such a business that can make decisions in real-time is sometimes referred to as a “Zero Latency Enterprise” (ZLE).

Unfortunately, conventional BAM infrastructure has a number of shortcomings, including the requirement that related activities must be in the same database to be monitored and the inability to handle data in cross-department interactions. These limitations severely restrict the usefulness of the BAM data existing in one or more databases managed under different business applications. For example, in a business entity that performs technical support for software products, a customer may find a critical bug in one of the software products and submit the finding to the technical support department. Technicians in the technical support department identify a course of action, including hiring a consultant to resolve the critical bug, requesting support from the product development department, or the like. During the course of action of resolving the critical bug, the technical support department may incur expenses (e.g., payment to the consultant) by submitting an expense report to the accounting department.

Consequently, the business may need to evaluate whether its courses of action led to customer satisfaction, whether money was spent efficiently, or other evaluations of effectiveness of its business decisions. Under the current BAM infrastructure, the business lacks this ability to organize data of these related business activities because these data exist in different databases controlled by different departments (e.g., technical support department, product development department and accounting department). In other words, in the technical support department's database, the record would only show that either a consultant was hired or the issue was reported to the product development department. Likewise, the accounting department's database would only show that an expense report was requested by the technical support department to pay for a consultant, without knowing that the consultant was paid to resolve the critical bug.

Another typical case that current BAM systems cannot handle is cross-department interaction. Usually, each department of a business has its own store for BAM data, with its own permissions, persons responsible for the data, etc. Thus, if some work {a} is done in department A, it will result in a record in A's BAM store. If department B is asked to do some related work {b}, it will leave tracking record only in the B's BAM store. If at a later time someone from department A decides to follow up on what happened, he or she would discover the record {a} but would have no way of discovering the progress, result, or even the existence of related work {b}.

Accordingly, improvements in business activity monitoring for navigation of business activities data and documents in a distributed environment are desired to address one or more of these and other disadvantages.

### SUMMARY OF THE INVENTION

Embodiments of the present invention overcome one or more deficiencies in the prior art by improving navigation of business activity data in a distributed system. For example, embodiments of the invention permit a user of one BAM system to retrieve information from another BAM system transparent to the user through the use of metadata or hyperlinks to the related data. In addition, embodiments of the present invention direct a user to all documents related to a business activity independent of which departments control the documents or where the documents are stored. A feature that enables embodiments of the present invention to overcome shortcomings of existing business activity monitoring is end-to-end visibility, i.e., that the user is able to follow the causality of business activities independently of their physical storage. For example, the user who is reviewing a purchase order activity should be able to discover related shipment or invoice activities, even if the instances these activities are stored in other places, and belong to other business departments.

In one embodiment, the scope of the distributed activity and document navigation is not limited to the departments within the same organization or enterprise; it may also be applicable across businesses with different applications managing their businesses. By way of example and not limitation, in order to monitor a purchase order from manufacture to delivery, a user may navigate different computer systems using the embodiments of the present invention to follow a shipment from the original manufacturer in China to the truck company in U.S.A., then to the sea cargo company, then to the trucking or railway company in Europe, etc. By granting proper permissions among these business entities, the user may follow the purchase order from his or her computer or web portal seamlessly and smoothly, without knowing where the actual information is stored.

According to one aspect of the invention, a method comprises monitoring multiple instances of a business activity in a distributed system. Relationships between data stored in at least one database and data stored in at least one other database are defined. The data in the at least one database is representative of one or more instances of a business activity and the data in the at least one other database is representative of one or more related instances of the business activity. A request is received from a user for business activity data independent of which database stores the requested data. One of the databases is navigated as a function of the defined relationships to retrieve the requested business activity data. The requested business activity data is provided to the user in response to the received request.

In accordance with another aspect of the invention, one or more computer-readable media comprise computer-executable instructions for organizing and accessing data in a distributed system. Data representative of multiple instances of a monitored business activity is collected. The data is stored in a plurality of databases. Relationships between data stored in at least one database and data stored in at least one other database are defined. In response to a request from a user for business activity data independent of which database stores the requested data, one of the databases is navigated as a function of the defined relationships to retrieve the requested business activity data. The requested data is retrieved according to the user's permission.

In accordance with a further aspect of the invention, a system for organizing and maintaining data accessible in one or more databases comprises a plurality of databases. The databases store data relating to multiple instances of a monitored business activity. A user interface receives a request from a user for business activity data independent of which database stores the requested data. An activity monitoring component navigates to one of the databases as a function of defined relationships to retrieve the requested business activity data. The user interface displays the retrieved data to the user based on the user's permission.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary flow diagram illustrating an example of business activity processing according to one embodiment of the invention.

FIG. 2 is an exemplary table containing data for supporting the business activity processing depicted in FIG. 1 according to one embodiment of the invention.

FIG. 3 is an exemplary block diagram illustrating existing model of handling data across departments relating to a business activity according to one embodiment of the invention.

FIG. 4 is an exemplary block diagram illustrating a user experience of navigating related data of a business activity according to one embodiment of the invention.

FIG. 5 is an exemplary block diagram illustrating a data structure for correlating data of a business activity across databases according to one embodiment of the invention.

FIG. 6 is an exemplary block diagram illustrating metadata synchronization of data of a business activity across databases according to one embodiment of the invention.

FIG. 7 is an exemplary block diagram illustrating correlating data of a business activity across databases using web services and portals according to one embodiment of the invention.

FIG. 8 is an exemplary flow diagram illustrating an operation of monitoring multiple instances of a business activity according to one embodiment of the invention.

FIG. 9 is an exemplary block diagram illustrating a system for organizing and maintaining data accessible in one or more databases according to one embodiment of the invention.

FIG. 10 is a block diagram illustrating one example of a suitable computing system environment in which the invention may be implemented.

Corresponding reference characters indicate corresponding parts throughout the drawings.

### DETAILED DESCRIPTION OF THE INVENTION

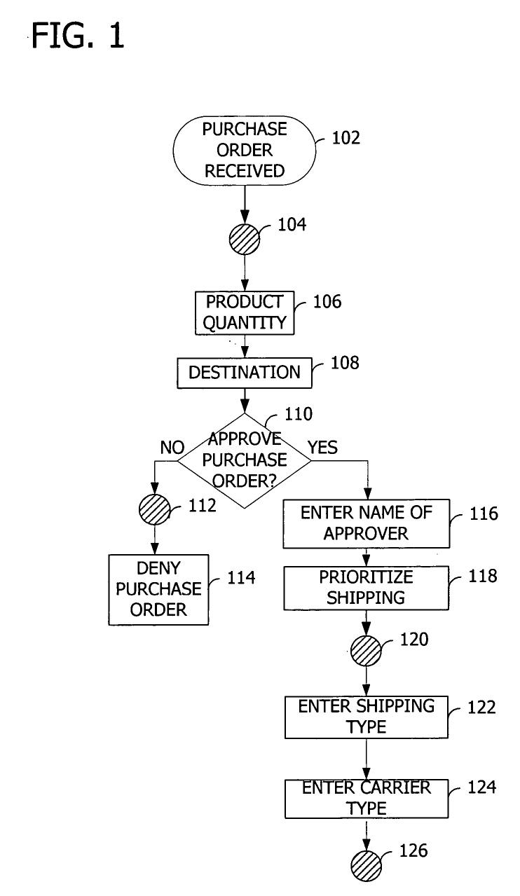

Referring first to FIG. 1, an exemplary flow diagram illustrates an example of a typical business activity such as purchase order processing according to one embodiment of the invention. Business activities include automated activities (e.g., completion of updating software applications or defragementing hard drives), physical activities (e.g., a truck driver delivering a package to a recipient), or a combination of both. In the illustrated embodiment, a purchase order is initially received at 102. It is to be understood that a plurality of instances of purchase orders may be received and each instance of purchase orders includes a set of data relating to the purchase order. In managing multiple instances of a business activity, one useful function is the ability to perform searches to filter and retrieve data efficiently. For example, one may be interested in performing a query, such as “Which purchase orders have an order value over $1000.00 and were submitted last week without receiving an approval/denial decision yet”

At 104, the purchase order reaches a milestone. For example, at the milestone at 104, data of a purchase order, such as the date when purchase order was received, the name of the person who took the purchase order, the name of the person who placed the purchase order or the like. It is to be understood that the milestone at 104 may be a stage of completion of certain tasks. As discussed earlier, many instances of purchase order activity may be running simultaneously and each instance may reach different stages of completion. Advantageously, one embodiment of the present invention is configured to record or collect data (e.g., time of reaching the milestone, or the like) at each milestone representing the completion of instances of the purchase order activity. Such recorded or collected data may be used to support queries about all instances of a business activity (e.g., purchase order activity) that are in progress or have already been completed. For example, in one embodiment, to support such queries, current time may be collected when a milestone is hit (e.g., at 104, 112, 120 and 126).

At 106, data relating to the product quantity of the purchase order is collected and, similarly data associated with the destination of the purchase order is collected at 108. At 110, a user determines whether to approve the purchase order. If the user determines to deny the purchase order, data of the time of the denial is collected at 112 and the decision to deny the purchase order is collected at 114. On the other hand, if the purchase order is approved, data including the name of the approver is collected at 116 and shipping is prioritized at 118. Once again, the purchase order activity reaches a milestone 120 and data relating to time and/or other data is collected. Next, data associated with shipping type of the purchase order is entered or collected at 122 before at 124 when the carrier type data is collected. The purchase order activity reaches another milestone at 126.

While FIG. 1 describes a typical purchase order activity, it is to be understood that other business activities with relevant milestones or stages of completions may be implemented without departing from the scope and spirit of the present invention. In addition, the types of data collected in describing FIG. 1 are used for exemplary purpose and not by means of limitations. Other operational data relating to a business activity may be collected for future queries and analysis.

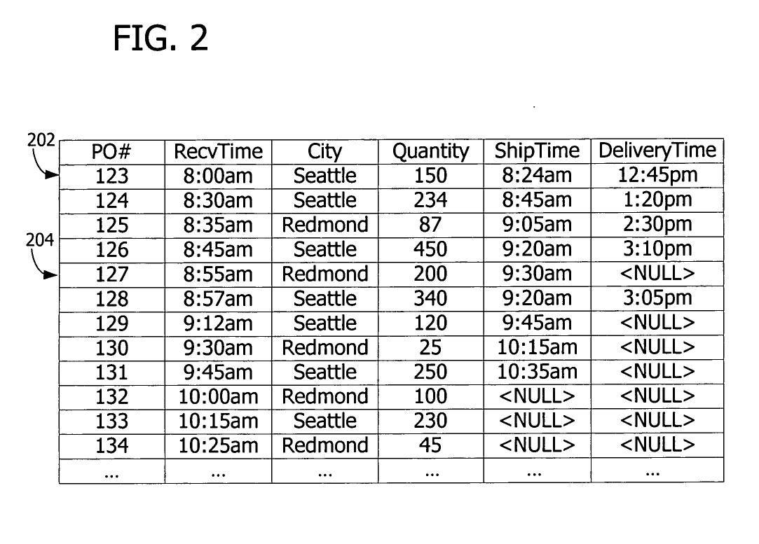

FIG. 2 is an exemplary table containing data for supporting the purchase order processing depicted in FIG. 1 according to one embodiment of the invention. In one embodiment, FIG. 2 illustrates the result of a query of purchase orders that have an order value over $1000.00 and were submitted last week without receiving an approval/denial decision. Each row (e.g., row 202) represents one instance of the purchase order activities. As shown in FIG. 2, when a new purchase order is received, a new row will be created in the table. Each column (e.g., RecvTime, City, Customer, Quantity, or the like) represents data collected at each milestone or a stage of completion and other data may be collected. Once a purchase order is approved and shipped, the “ShipTime” will be set to a non-null value. Finally, when the shipment of the purchase order is received and confirmed, the DeliveryTime will be set to a non-null value. For example, purchase order (“PO”) #123 has an order reception time of 8:00 am with a delivery destination city of Seattle. The PO #123 requests a quantity of 150 units and this order was shipped at 8:24 am and it was delivered at 12:45 pm. In row 204, purchase order 127 has an entry <NULL> for its delivery time indicating that this order has not been delivered or such information is not available yet. In one embodiment, the table in FIG. 2 may be used as a table for process query in a typical SQL query.

While FIG. 2 is shown using a typical table, other data structures may be used. For example, if the data provided in the table in FIG. 2 is stored in one database, a business user may formulate queries against this table using a client user interface (e.g., either through an application that connects directly to the database that stores the data or via intermediate web pages and web services). Because all the data relating to the business activity is stored in one database in this illustrated example, FIG. 2 is sufficient to make the data available in a table. Unfortunately, it is common that not all data relating to a business activity is stored in one database. It is also a common practice that departments within one organization store data in different and separate databases, not along using different software applications for the departments.

Commonly assigned U.S. patent application Ser. No. 10/750,885, filed on Jan. 5, 2004, entitled “CORRELATING PROCESS INSTANCE DATA ACROSS MULTIPLE APPLICATIONS”, the entire disclosure of which is incorporated herein by reference, discloses suitable means for generating a table, such as shown in FIG. 2, for maintaining information received from multiple sources regarding multiple instances of an activity.

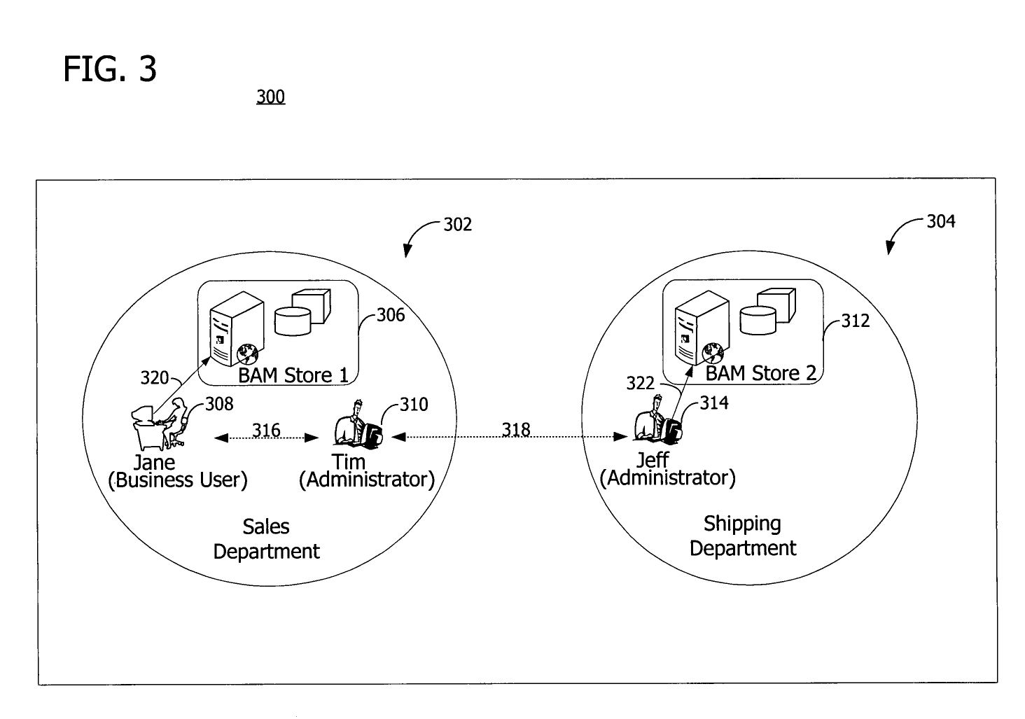

FIG. 3 illustrates one example of when a business user in one department attempts to access data stored in a different department. Referring to FIG. 3, a block diagram shows an exemplary environment in which embodiments of the invention are useful for providing business activity monitoring between departments. A system 300 handles data across departments relating to a business activity according to one embodiment of the invention. By way of example, a sales department 302 is an internal department within an organization and a shipping department 304 is another internal department within the same organization. In another embodiment, the sales department 302 may be an internal department within one organization while the shipping department 304 is an internal department within a separate organization.

Initially, an IT administrator 310 (e.g., Tim) of sales department 302 grants a business user 308 (e.g., Jane) of sales department 302 to access data stored in a storage 306 (e.g., BAM store 1). In the illustrated embodiment, IT administrator 310 is solely responsible for the availability and security of data in this sales department 302 and grants permissions to the business user 308, Jane, to view subsets of the data. In other words, the administrator 310, Tim, owns the infrastructure for the sales department. For business user 308, the center of the world is the purchase order activity in sales department 302 in which she participates. As a result, her direct access (e.g., home page) is set up to access storage 306 (e.g., BAM pages installed on a server to access storage 306) and such access is maintained by Tim, IT administrator 310.

Similarly, another IT administrator 314 (e.g., Jeff) of shipping department 304 grants a business user (not shown) of shipping department 304 access to data stored in a storage 312 (e.g., BAM store 2). The IT administrator 314, Jeff, is responsible for meeting the needs of sales department 304. Further to the example, the Shipping Department 304 may also be responsible for shipments relating to warranty repairs, item returns, internal relocation cases, or the like.

It is to be understood that IT administrator 310, Tim, attempts to configure servers, applications and storage 306 of sales department 302 as independent from other systems (e.g., shipping department 304) as possible because of business and security reasons. For example, IT administrator 310 generally may not want purchase order activities in sales department 302 or query functionalities for his business users 308 to be affected when the infrastructure or storage 312 of IT administrator 314, Jeff, is unavailable. Likewise, IT administrator 314 may not wish to configure shipping department 304 to depend on IT administrator 310 or sales department 302, and may wish to permit business users of shipping department 304 to be able to follow the progress of the shipping activities, even if sales department 302 is unavailable. While this division of ownership and separate independency is practical, this practice significantly limits a business user's ability and efficiency to access data across departments under the conventional BAM systems.

For example, suppose business user 308, Jane, attempts to view or access shipments or shipping data related to a purchase order A in sales department 302 (as shown by arrow 320), business user 308 does not know that shipping data may be administered or controlled by another department or entity (e.g., Jeff) instead of IT administrator 310, Tim, of sales department 302. An inefficient approach for business user 308 to access shipping data may be to ask IT administrator 314, Jeff, (e.g., via arrows 316 and 318) to grant her permissions to access shipment data. Subsequently, business user 308 may use the web pages of IT administrator 310 for business queries on purchase orders, but may be required to use the pages (e.g., a separate user interface) of IT administrator 314 to follow data relating shipments about the purchase order A.

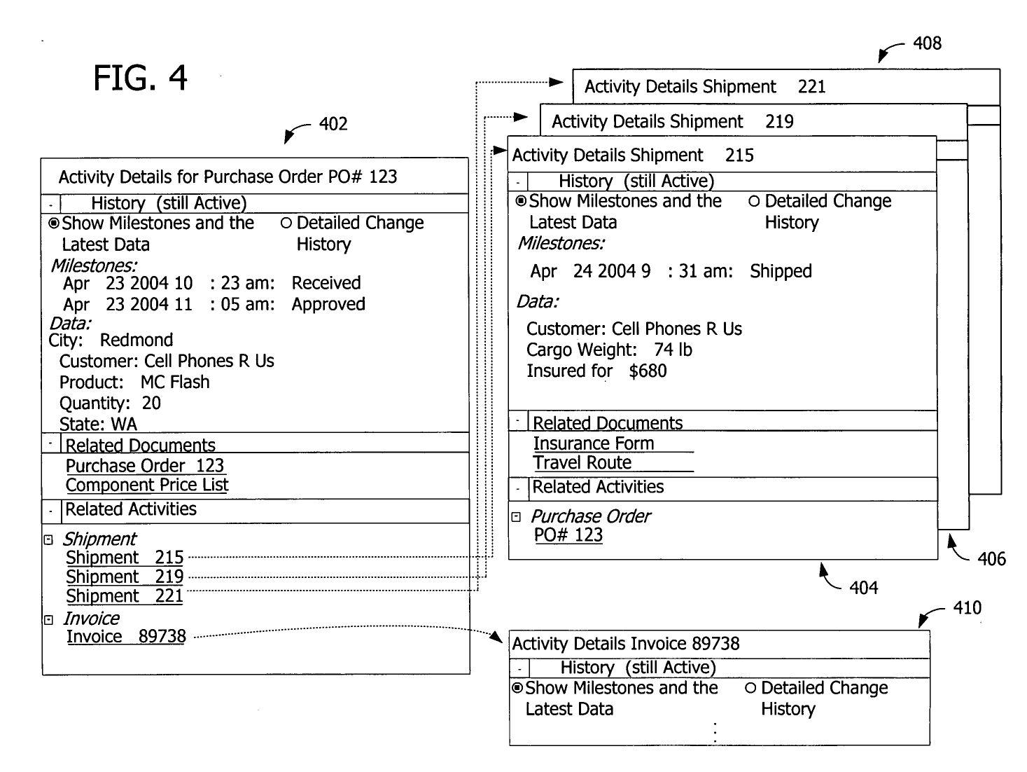

Embodiments of present invention provide business user 308 (e.g., Jane) a seamless user experience in retrieving data relating to a business activity as shown in FIG. 4. FIG. 4 illustrates an exemplary block diagram depicting a user experience of navigating related data of a business activity according to one embodiment of the invention. A display window 402 displays activity details of a monitored business activity (e.g., PO #123) for business user 308 in sales department 302. The display window 402 provides data collected from during a typical purchase order processing, as depicted in FIG. 1. For example, under the “History (still Active)” section, when “Show Milestones and the Latest Data” is selected, display window 402 displays that PO #123 was received on Apr. 23, 2004 at 10:23 am and the order was approved on Apr. 23, 2004 at 11:05 am. Similarly, other data relating to this order, such as City, Customer, Product, Quantity, or the like is provided to business user 308. Likewise, when “Detailed Change History” is selected, other data will be provided to business user 308.

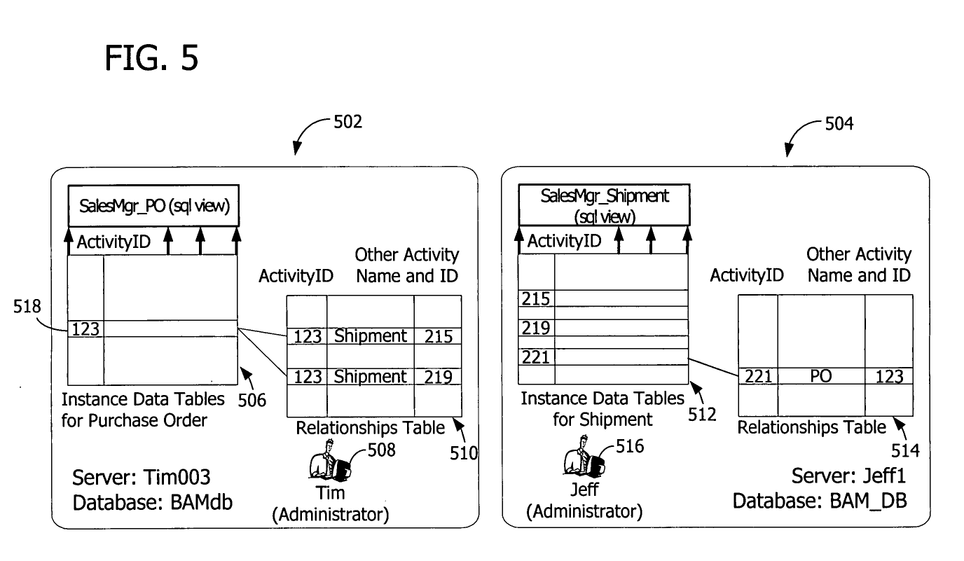

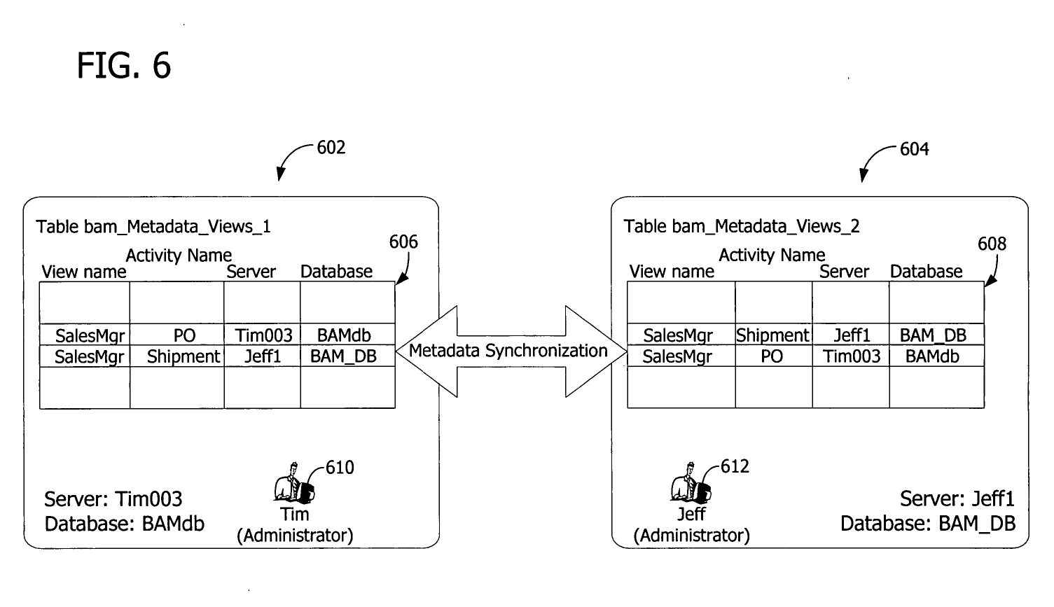

In addition, display window 402 also includes sections, such as “Related Documents” and “Related Activities”. Using the current example, display window 402 presents Shipment and Invoice data that are related to the PO #123. In particular, within Shipment activity, three shipments (e.g., 215, 219 and 221) are related to the PO #123. (Refer to discussions on FIGS. 5 and 6 for relationships between business activities). For example, shipment 215 may only contain 10 of the 20 units ordered while shipments 219 and 221 may contain only 5 units each. While these three shipments may be treated as three separate and independent shipments by shipping department 304, they are all part of the PO #123 and thus are all organized under “Related Activities” section of PO #123.

The business user 308 may learn more about shipment activity by using, for example, a pointing device (e.g., a mouse) to click on “Shipment 215”, “Shipment 219” or “Shipment 221.” In this example, the underlining of each shipment indicates that each shipment is a clickable link for a user to select and to receive details about the selection in a display window. For example, when business user 308 uses a mouse to click on “Shipment 215” in display window 402, a separate display window 404 displays details about “Shipment 215”. In the display window 404, the details of “Shipment 215” show that the shipment 215 was shipped on Apr. 24, 2004 at 9:31 am. In addition, other data such as Customer name, Cargo Weight and Shipment insurance were collected for this shipment. Also, under the “Related Activities”, display window 404 shows that PO #123 is related to this shipment. Similarly, when business user 308 clicks on “Shipment 219” in display window 402, a display window 406 displays the details of Shipment 219, and a display window 408 displays the details of Shipment 221 when business user 308 clicks on “Shipment 221” in display window 402.

Also, under the “Related Activities” section in display window 402 for PO #123, invoice 89738 is another related activity for PO #123 and when business user clicks on “Invoice 89738” in display window 402, a display window 410 displays the details of Invoice 89738.

As shown in FIG. 4, embodiments of the present invention presents information relating to all data of a monitored business activity to a business user in a seamless fashion because business user 308 (e.g., Jane) is not interested in knowing where the information is; she is interested in gathering a complete and comprehensive result after she requests information on a business activity (e.g., PO #123). It would be time-consuming and inefficient for business user 308 to individually determine where and how a particular piece of data may be accessible.

FIG. 5 is an exemplary block diagram illustrating a data structure for correlating data of related business activities across databases according to one embodiment of the invention. It is to be understood that a trust relationship is already established between the two databases (e.g., storages 306 and 312). For example, an IT administrator 508 (e.g., Tim) and another IT administrator 516 (e.g., Jeff) perform explicit administrative actions to enable the remote references, i.e. the trust relationship, between storages (e.g., BAM stores) 306 and 312 of sales department 502 and shipping department 504, respectively.

In one embodiment, IT administrator 508 creates a specific view or environment 506 for a type of business user. For example, for business user 308 who is a sales manager in sales department 302, IT administrator 508 may create a role specific view 506 (e.g. SalesMgr_PO), where SalesMgr stands for the role of business user 308 in which business user 308 belongs. In another embodiment, more than one view may be created to present a snapshot or a portion of the same activity data. For example, IT administrator 508 may filter out some data that users in some roles who are not interested in or are not allowed to view.

Also, a relationships table 510 contains the information or hint of other business activities and/or documents that may be related to a monitored business activity. In one embodiment, relationships between data stored in one database (e.g., BAM store 306) and data stored in another database (e.g., BAM store 312) are defined by an administrator (e.g., IT administrator 508). For example, when business process for instance 518 of purchase order activity (e.g., PO #123) is executed, records may be stored in the relationships table 510 such as “Shipment 215” and “Shipment 219”. In one embodiment, relationships table 510 stores reference hint, not the actual shipment activity information. In another embodiment, the data provided in relationships table 510 or 514 is not pointing to the physical location of the data. By providing hints in relationships table 510 or 514, embodiments of the present invention are flexible to accommodate changes to physical location of the data since the physical location of the data may change over time (e.g. if Tim decides to rename his servers).

Likewise, in shipping department 504, instances of shipment activities take place inside shipping department 504 and IT administrator 516 (e.g., Jeff) creates a role-specific view 512 (e.g., SalesMgr). Along with instances of shipping activities, some more relationship records may be created. For example, a relationships table 514 contains the information or hint of other business activities and/or documents that may be related to a monitored instance of shipping activities. For example, when the business process for shipment 221 is executed, records are created in the relationships table 514 showing a related activity instance (e.g., “PO #123”). In one embodiment, hints provided in relationships table 514 may duplicate the reference data on sales department 502. In another embodiment, hints in relationships table 514 may contain unique information independent of reference data in other department or entities.

Referring to FIG. 6, an exemplary block diagram illustrates metadata synchronization of data of a business activity across databases according to one embodiment of the invention. As part of regular business activities in a business enterprise, for example, a business user may initially indicate that purchase order PO #123 will be shipped in two shipments: #215 and #219. Consequently, the business user provides this information to the sales department. However, when the business user determines that the PO #123 would be shipped in three separate shipments at a later time (e.g., an additional shipment 221), the sales department may not be aware of this additional shipment #221.

Under conventional BAM systems, the business user in the shipping department would only create a record of this third and additional shipment 221 to fulfill PO #123 in the shipping department, but would fail to reference this shipment 221 to PO #123 in the sales department. Alternatively, while the business user in the shipping department may reference the shipment 221 as a related activity to PO #123, this piece of information may not be available to the sales department where PO #123 was received. This disadvantage of conventional systems does not provide a complete and comprehensive picture of the purchase order processing of PO #123.

To the contrary, FIG. 6 illustrates an exemplary embodiment where metadata tables (e.g. bam_Metadata_Views_1 602 and bam_Metadata_Views_2 604) store information including the physical location of the business activities in any view. For example, metadata tables 602 and 604 provide information for business users, such as business user 308, Jane, in the sales department or another business user in the shipping department. The content of metadata tables 602 or 604 is simply synchronized among the trusted BAM stores on scheduled or periodic basis. For example, in bam_Metadata_Views_1 602 includes data such as a table containing “View name” (e.g., SalesMgr), “Activity Name” (e.g., PO or Shipment), “Server” (e.g., Tim003 or Jeff1), “Database” (e.g., BAMdb or BAM_DB) or the like. It is to be understood other information may be included and may be presented in another format, such as a list or the like.

In one embodiment, a user interface (UI) (e.g., user interface 906) may be used in conjunction with metadata tables 602 or 604. For example, the UI reads or obtains the content of the bam_Metadata_Views_1 602 and presents the business user with a list of the BAM Views they have permission to. For example, business user 308 of the sales department may only be permitted to view data (e.g., purchase order activities) as configured by IT administrator 310. In another embodiment, IT administrator 310 may determine the permission of a business user by identifying whether the business user is a member of at least one network group that is a member of the SQL Role for the SalesMgr View.

As the UI obtains the content of the metadata tables 602 and 604, a business user selects a view and/or activity of interest. For example, business user 308, Jane, may select “SalesMgr” View and “PO” Activity. In one embodiment, business user 308 may formulate a query after selecting the desired view and/or activities. For example, business user 308 may be interested in all unpaid orders with order amount less than $1,000.00. The UI displays the requested results and business user 308 may select one of the results to monitor detailed history and data, as depicted in display window 402 in FIG. 4.

In one embodiment, business user 308 monitors an instance of a business activity (e.g., purchase order processing) and views its detailed history and data. In addition to the data that is available in the activity record, the UI presents business user 308 with links (e.g., URLs) of all the Related Activities. In another embodiment, in presenting business user 308 with links of all the Related Activities, the UI performs the following steps, such as retrieve all relationships that were tracked in the same database as the activity instance data; retrieving the server and database for each activity in the current view; connecting from the current database for each activity to the corresponding database and retrieving the reverse relationships between the activities (e.g., retrieving the relationship between PO#123 and Shipment 221.)

In another embodiment, the UI constructs the link (e.g., URL) for each of the related activity instances discovered. For example, the data may be identified and shown to business user 308 by Activity name and Instance ID while the body of the link contains ActivityName, ActivityID, Server, Database or the like. In yet another embodiment, the UI may remove duplicate links caused by having the same reference information on both databases. Using PO 123 as an example, the following programming statements (e.g., SQL) may be executed in a first database:

SELECT OtherName,OtherID
FROM RelTable
WHERE ActivityID=’123’

Next, for each activity type X that may be related to ActivityID 123,

SELECT ‘X’,OtherID
WHERE OtherName=”PO”

The result of the execution, for example, provides a list of possibly related activities X and the corresponding databases from the metadata table. In one embodiment, the result is presented as rowsets i.e. {ActivityName,ID} such that the result shown to the user is the union after removing the duplicate pairs.

In a further embodiment, metadata tables 602 and 604 are periodically synchronized. According to this embodiment of metadata tables, a user may navigate through one or more databases retrieving data and/or documents stored in one or more databases when a user clicks on or selects the link of an instance in the “Related Activity” in a display window of the UI (e.g., display window 402). The UI connects the user to the Server and Database from the link and retrieves the details about the related activity instance (e.g. Shipment 221).

It is to be understood that there is a globally known Role (e.g., Sales Manager), a central authentication, periodically synchronized metadata tables, or the like to provide a seamless distributed navigation, such as an intranet.

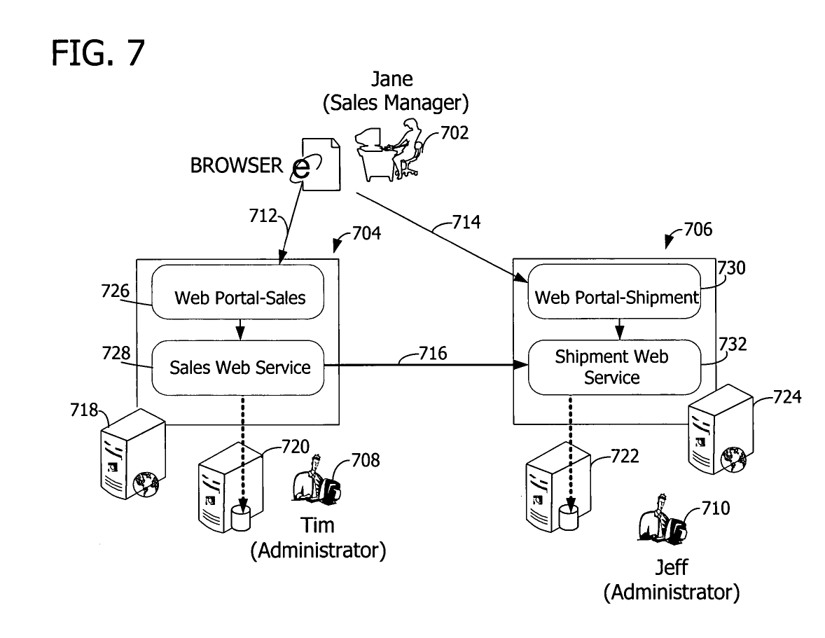

Alternatively, FIG. 7 describes an exemplary block diagram illustrating correlating data of a business activity across databases using web services and portals according to another embodiment of the invention. In this embodiment, a business user 702 may be a sales manager of the sales department of one organization 704. The sales department or the organization has an administrator 708, Tim, to manage and configure a web server 718 and a database 720. An administrator 710, Jeff, on the other hand, manages and configures a web server 724 and a database 722 of another business organization 706 that handles shipping business activities. It is to be understood that although the administrator 708 and the administrator 710 are described in the context of different entities, they may be described in the context of being in different and separate departments of one organization.

In one embodiment, the web server 718 supports its own web service while the web server 724 supports its web service independent from that of web server 718. In another embodiment, the web services supported by web servers 718 and 724, and are part of a “trusted” web services (e.g., business organizations 704 and 706 are partner businesses).

Initially, business user 702, Jane, connects to Web Portal-Sales 726 from her computer/workstation via a wireless or wired connection 712. For example, Jane opens her homepage (e.g., using a web browser) which is connected to Web Portal for the Sales department via an internet or an intranet. In one embodiment, in order to navigate to retrieve or access the related shipment activity, the Web Portal will call or be connected to a shipment web service 732. For example, a sales web service 728 hosted by web server 718 will call the trusted shipment web service 732 hosted by web server 724 to determine what types of activities are available to user 702, Jane, according to her permission.

It is to be noted that administrator 710, Jeff, has granted permission of sales web service 728 to call shipment web service 732 and access specific data stored in database 722. It is also to be understood that the grant of permission to sales web service 728 by administrator 710 permits all users in the sales department of business organization 704 to access the subset of data. For example, administrator 710 gives permission to sales web service 728 as a whole (e.g., disregard individual users' roles) to access a subset of data stored in the database 722 where the shipment data is related to purchase orders (e.g., sales) from business organization 704.

After a trust relationship is established between sales web service 728 and shipment web service 730, shipment web service 730 returns to business user, 728, Jane, a set of links (e.g., hyperlinks) pointing either to a local web portal (e.g., Web Portal-Sales 726), or to some trusted web portal (e.g., Web Portal-Shipment 730). For example, two links are returned: “Purchase Order” (local portal) and “Shipment” (remote portal) to business user 702, Jane. In another embodiment, in addition to the links, other contextual information may be transmitted to ensure security (e.g. public key used by shipment web service 732) over https, tracking cookies, encryption, or the like.

After receiving the links, business user 702, Jane, may click on some of the links to formulate a query about this type of activities. For example, by using one of the services by sales web service 728, business user 702 sends a request to search shipping business activity data relating to purchase orders. The business user 702 selects one of the searched results (e.g., PO #123) of her query request and the selected purchase order has a related shipment activity. From that point, the browser of business user 702 will communicate with the corresponding portal (e.g., web portal-sales 726 or web portal-shipment 730). For example, user 702 selects PO #123 and received details about this purchase order instance when Web Portal-Sales 726 calls sales web service 728 to retrieve the links to the related activity instances. The sales web service 728 will call each trusted web service (e.g., shipment web service 732) and determines its own database to construct a global list of all activity types to which business user 702 has access. The sales web service 728 next provides the link (e.g., URL) of the corresponding web services to business user 702, Jane.

In one embodiment, sales web service 728, for each of those activity types, perform a forward-scan of the relationship table (e.g., relationships table 510 or 514) for the current activity type (e.g., purchase orders in FIG. 4). For example, the forward-scan of the purchase order PO #123 retrieves shipments 215 and 219 are related to PO #123. Since the sales web service 728 recognizes the provider of “Shipment” activity (e.g., through partnership), sales web service 728 will return two links for each of the shipments pointing to Web Portal-Shipment 730.

In another embodiment, sales web service 728 requests the corresponding web service (e.g., shipment web service 732) to perform a reverse-scan for the activities related to the original instance for each of the activity types. For example, shipment web service 732, when performing the reverse-scan, will discover shipment 221 is also related to PO #123 and shipment web service 732 will return a link pointing to Web Portal-Sales 726.

In yet another embodiment, Web Portal-Sales 726 will show each of the returned links as a hyperlink on which the user can click (see FIG. 4). By clicking on the hyperlink, the browser of business user 702 will abandon the current web portal and switch to the targeted portal (as shown via arrow 714). For example, after business user 702 discovers that three shipments (e.g., 215, 219 and 221) are related to PO #123, business user 702 will be taken to Web Portal-Shipment 730 when she clicks on “Shipment 221”.

This assumes of course that those businesses granted the proper permission to their partners to follow the activities further. An exemplary restriction would be to identify the activity data but not allowing further navigation of the relationships existed between data.

In yet another embodiment, when a trusted business partner modifies its link structure (e.g., change of domain name, restructuring of file hierarchy, or the like), administrator 708, Tim, or administrator 710, Jeff, would only need to reconfigure the trusted web service's link, not each individual links of related data. For example, because it is only the link to the type of activity that is stored as data, not the link to the actual location of the data in a database, administrator 708 would only need to change the overall link structure of the trusted web service to accommodate a URL change.

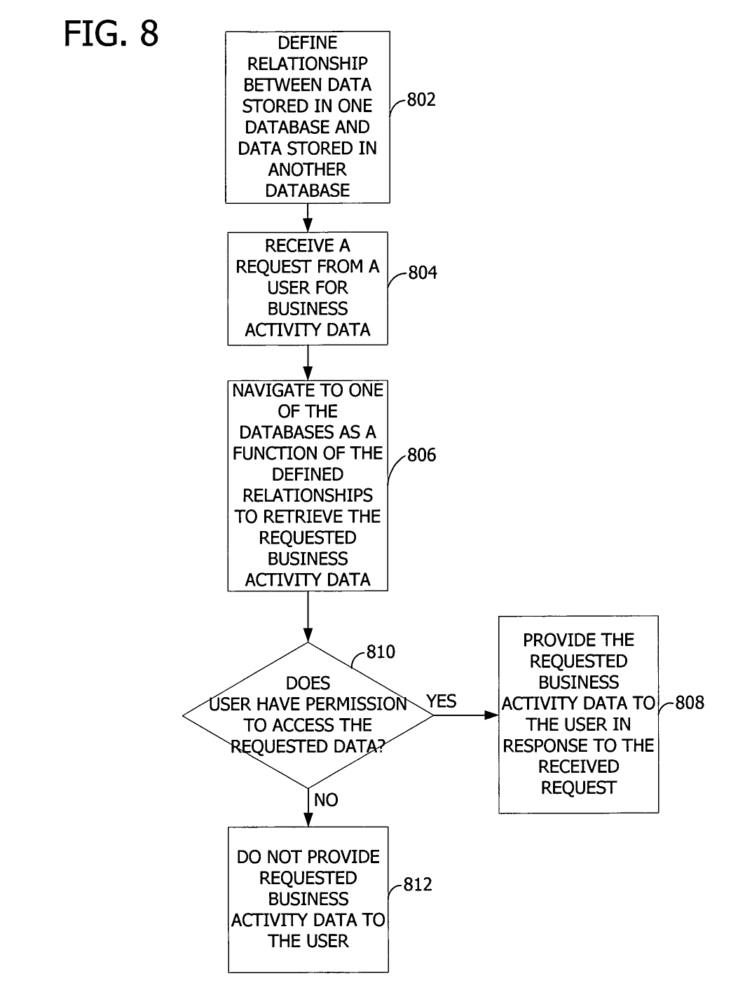

Referring now to FIG. 8, an exemplary flow diagram illustrates an operation of monitoring multiple instances of a business activity according to one embodiment of the invention. Initially, a service component (e.g., sales web service 728) defines relationships between data stored in one database and data stored in another database at 802. For example, the data in one database is representative of one or more instances of a business activity (e.g., purchase orders in database 720) and the data in another database is representative of one or more related instances of the business activity (e.g., shipping activity data in database 722). At 804, the service component receives a request from a user for business activity data independent of which database stores the requested data. For example, sales web service 728 receives a purchase order query from business user 702, Jane, searching for unpaid purchase orders with order amount less than $1,000.00. At 806, the service component navigates to one of the databases as a function of the defined relationships to retrieve the requested business activity data. For example, before business user 702 may retrieve the requested data, at 810 the service component determines whether business user 702 is permitted to access the requested data. If business user 702 is permitted (e.g., she is a sales manager), the requested business activity data is provided to business user 702, Jane, in response to the received request at 808. Alternatively, if the service component determines that business user 702 is not permitted to access the requested data, the service component does not provide the requested business activity data to business user 702 at 812.

In another embodiment, one or more computer-readable media having computer-executable instructions for organizing and accessing data in a distributed system comprise collecting data representative of multiple instances of a monitored business activity where data is stored in a plurality of databases. The computer-readable media also include defining relationships between data stored in at least one database and data stored in at least one other database. The computer-readable media further include navigating, in response to a request from a user for business activity data independent of which database stores the requested data, to one of the databases as a function of the defined relationships to retrieve the requested business activity data. The computer-readable media also comprise retrieving the requested data according to the user's permission.

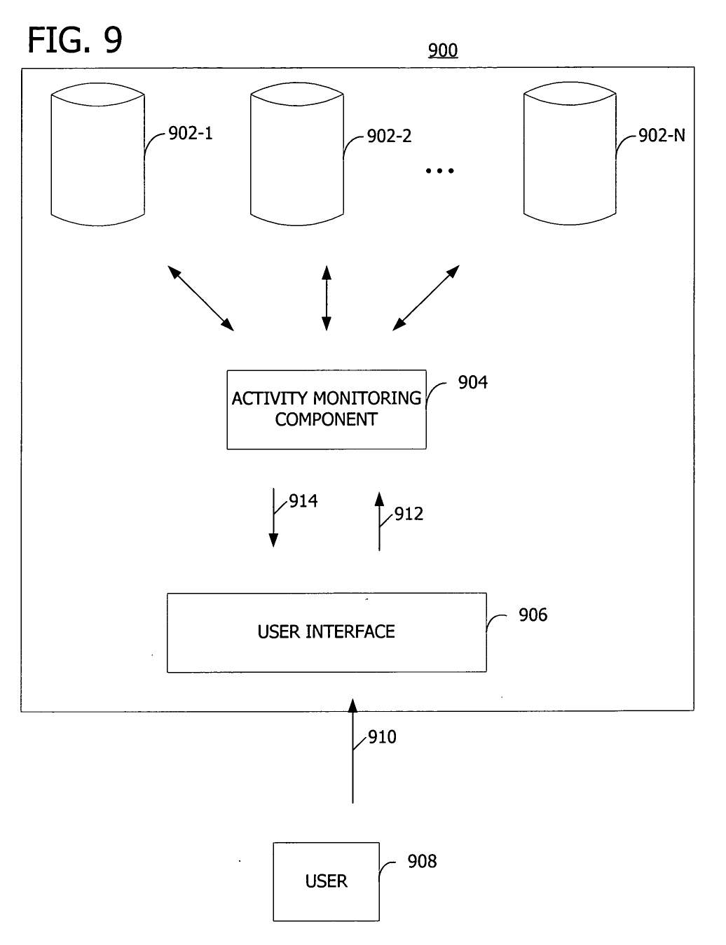

Referring to FIG. 9, an exemplary block diagram illustrates a system 900 for organizing and maintaining data accessible in one or more databases according to one embodiment of the invention. The system 900 includes a plurality of databases 902 for storing data relating to multiple instances of a monitored business activity. In another embodiment, system 900 may be a distributed system managing one or more databases 902 belonging to one or more sub-systems. For example, database 902-1 may be a database, such as storage 306 of a department (e.g., sales department), and database 902-2 may be another database, such as storage 312 of another department (e.g., shipping department), of the same organization. In one embodiment, system 900 defines relationships between data stored in one database 902-1 and data stored in another database 902-2.

The system 900 also includes a user interface (UI) 906 for receiving a request via an input device 910 (e.g., a mouse or a keyboard) from a user 908 for business activity data independent of which database stores the requested data. For example, the user 908, such as business user 702, may perform a search or query of purchase orders in sales department. In providing user 908 results of her request, system 900 includes an activity monitoring component 904 for navigating to one of the databases as a function of defined relationships to retrieve the requested business activity data. For example, after receiving the request from user 908 via the input device 910, user interface 906 transmits the request to the activity monitoring component 904 via a connection 912. As a function of the defined relationships between data stored in databases 902, activity monitoring component 904 retrieves the requested business activity data. The activity monitoring component 904 next transmits the requested business activity data to user interface 906 via a connection 914. The UI 906 displays the retrieved data on a display to the user based on the user's permission (e.g., whether user 908 has permission to access data relating to a particular business activity).

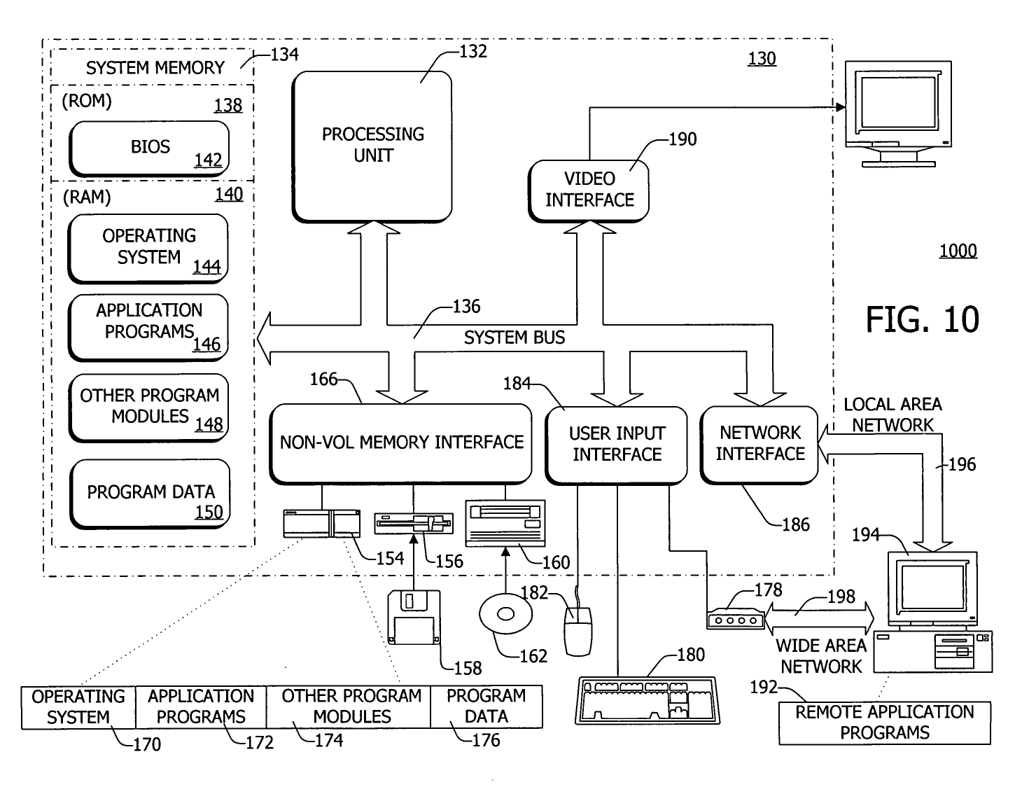

FIG. 10 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 10 illustrates operating system 144, application programs 146, other program modules 148, and program data 150.

The computer 130 may also include other removable/non-removable, volatile/nonvolatile computer storage media. For example, FIG. 10 illustrates a hard disk drive 154 that reads from or writes to non-removable, nonvolatile magnetic media. FIG. 10 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 10, provide storage of computer readable instructions, data structures, program modules and other data for the computer 130. In FIG. 10, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 10 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 10 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above system and method without departing from the scope of the invention, it is intended that all matter contained in the above description and shown in the accompanying drawings shall be interpreted as illustrative and not in a limiting sense.

What is claimed is:

1. A method of monitoring multiple instances of a business activity in a distributed system, said method comprising:
defining relationships between data stored in at least one database and data stored in at least one other database, said data in the at least one database being representative of one or more instances of a business activity and said data in the at least one other database being representative of one or more related instances of the business activity;
receiving a request from a user for business activity data independent of which database stores the requested data;
navigating to one of the databases as a function of the defined relationships to retrieve the requested business activity data; and
providing the requested business activity data to the user in response to the received request.

2. The method of claim 1 wherein the defined relationships include locations of the business activity data in the at least one.

3. The method of claim 2 wherein defining relationships includes maintaining metadata tables containing the locations of the business activity data relative to the databases and wherein navigating to one of the databases includes identifying the location of the requested business activity data from the metadata tables.

4. The method of claim 3 further comprising periodically synchronizing the metadata tables.

5. The method of claim 1 further comprising directing the user to the requested business activity data via a link to a web portal hosted by the distributed system, said web portal directing the user to access the data.

6. The method of claim 1 further comprising establishing a trust relationship among the one or more databases and permitting a query for the requested business activity data only between trusted databases.

7. The method of claim 1 further comprising determining whether the user has permission to receive the requested business activity data before providing the data to the user.

8. The method of claim 1 wherein one or more computer-readable media have computer-executable instructions for performing the method recited in claim 1.

9. One or more computer-readable media having computer-executable instructions for organizing and accessing data in a distributed system, said instructions comprising:
collecting data representative of multiple instances of a monitored business activity, said data being stored in a plurality of databases;
defining relationships between data stored in at least one database and data stored in at least one other database;
navigating, in response to a request from a user for business activity data independent of which database stores the requested data, to one of the databases as a function of the defined relationships to retrieve the requested business activity data; and
retrieving the requested data according to the user's permission.

10. The computer-readable media of claim 9 wherein defining relationships between the data comprises correlating the collected data based on relationships among the data.

11. The computer-readable media of claim 9 wherein said instructions further comprise establishing a trust relationship among the one or more databases and wherein navigating comprises permitting a query for the requested business activity data only between trusted databases

12. The computer-readable media of claim 9 wherein said instructions further comprise periodically synchronizing metadata tables containing the locations of the business activity data relative to the databases, and wherein navigating to one of the databases includes identifying the location of the requested business activity data from the metadata tables.

14. The computer-readable media of claim 9 wherein said instructions further comprise directing the user to the requested business activity data via a link to a web portal hosted by the distributed system, said web portal directing the user to access the data.

15. A system for organizing and maintaining data accessible in one or more databases, said system comprising:
a plurality of databases storing data relating to multiple instances of a monitored business activity;
a user interface for receiving a request from a user for business activity data independent of which database stores the requested data;
an activity monitoring component for navigating to one of the databases as a function of defined relationships to retrieve the requested business activity data, said user interface displaying the retrieved data to the user based on the user's permission.

16. The system of claim 15 further comprising a query component for establishing a trust relationship among the databases and permitting a query for the requested business activity data only between trusted databases.

17. The system of claim 15 wherein the activity monitoring component retrieves relationship information among the data in the plurality of databases.

18. The system of claim 15 wherein the user interface further comprising providing a link to the user, said link directing the user to the requested data.

19. The system of claim 15 wherein the user interface further comprising providing metadata to the user, said metadata identifying locations of the business activity data relative to the databases and wherein the activity monitoring component navigates to one of the databases based on the location of the requested business activity data identified by the metadata.

20. The system of claim 19 wherein the activity monitoring component periodically synchronizes the metadata.
